(19) United States
(12) Patent Application Publication
(10) Pub. No.: US 2019/0382228 A1
(43) Pub. Date: Dec. 19, 2019

(54) STACKER AND IMAGE FORMING SYSTEM

(71) Applicant: KONICA MINOLTA, INC., Tokyo (JP)

(72) Inventor: Yu MATSUNAGA, Tokyo (JP)

(73) Assignee: KONICA MINOLTA, INC., Tokyo (JP)

(21) Appl. No.: 16/398,526

(22) Filed: Apr. 30, 2019

(30) Foreign Application Priority Data
Jun. 13, 2018 (JP) 2018-112436

(51) Int. Cl. B65H 31/24; B65H 29/60; B65H 39/02; G03G 15/00

(52) U.S. Cl. CPC B65H 31/24; B65H 29/60; B65H 39/02; G03G 15/6552; G03G 2215/00751; B65H 2801/27; B65H 2511/10; B65H 2515/10; G03G 2215/00421; B65H 2405/10

(57) ABSTRACT

A stacker includes: an ejector that ejects a sheet on which an image is formed depending on a print job to an ejection destination; a first tray on which the sheet ejected by the ejector is stacked, as the ejection destination; a second tray that is a delivery destination of the sheet stacked on the first tray and with which automatic external ejection processing that ejects the sheet externally is executable; a setter that accepts a setting detail in which it is set whether or not to execute the automatic external ejection processing executable with the second tray; and a controller that controls whether or not to execute the automatic external ejection processing depending on the setting detail, wherein the hardware processor continues stacking of the sheet on the first tray when not executing the automatic external ejection processing.

The entire disclosure of Japanese patent Application No. 2018-112436, filed on Jun. 13, 2018, is incorporated herein by reference in its entirety.

### BACKGROUND

### Technological Field

The present disclosure relates to a stacker and an image forming system.

### Description of the Related Art

Recently, an image forming apparatus, such as an electrophotographic copying machine, a printer, a facsimile machine, or a multifunction machine in which these are combined, is provided with a stacker for stacking of sheets on which images are formed. A stacker has been devised that is connected to a post-processing apparatus that performs post-processing, such as binding processing, folding processing, gluing processing, or the like, to achieve more efficient office work (for example, see JP 2014-114109 A and JP 2009-269303 A).

However, in conventional techniques as described in JP 2014-114109 A and JP 2009-269303 A, when an ejection condition is satisfied, stacking operation is stopped that stacks sheets on a tray, and ejection operation is executed that ejects the sheets stacked on the tray externally. Thus, if the ejection operation cannot be performed, the stacking operation may also be in a standby state until a state is restored in which the ejection operation can be performed. In addition, if the ejection operation is executed when the ejection condition is satisfied, even a highly confidential document may be ejected externally. There is therefore possibility that productivity is reduced and security is reduced.

### SUMMARY

The present disclosure has been made in view of such a situation, and is intended to enable implementation of maintenance of the productivity and improvement of the security.

To achieve the abovementioned object, according to an aspect of the present invention, a stacker reflecting one aspect of the present invention comprises an ejector that ejects a sheet on which an image is formed depending on a print job to an ejection destination; a first tray on which the sheet ejected by the ejector is stacked, as the ejection destination; a second tray that is a delivery destination of the sheet stacked on the first tray and with which automatic external ejection processing that ejects the sheet externally is executable; a setter that accepts a setting detail in which it is set whether or not to execute the automatic external ejection processing executable with the second tray; and a hardware processor that controls whether or not to execute the automatic external ejection processing depending on the setting detail, when the sheet satisfies a target condition in which the sheet becomes a target sheet of the automatic external ejection processing, wherein the hardware processor continues stacking of the sheet on the first tray when not executing the automatic external ejection processing.

### BRIEF DESCRIPTION OF THE DRAWINGS

The advantages and features provided by one or more embodiments of the invention will become more fully understood from the detailed description given hereinbelow and the appended drawings which are given by way of illustration only; and thus are not intended as a definition of the limits of the present invention:

FIGS. 1A and 1B are left side views of a stacker according to a first embodiment of the present disclosure;

FIG. 2 is a front view of the stacker according to the first embodiment of the present disclosure;

FIG. 3 is a block diagram illustrating a functional configuration of the stacker according to the first embodiment of the present disclosure;

FIGS. 4A to 4F are left side views illustrating a change of a position of a first tray according to the first embodiment of the present disclosure;

FIG. 5 is a flowchart illustrating automatic external ejection processing according to the first embodiment of the present disclosure;

FIG. 6 is a flowchart illustrating target sheet determination processing according to the first embodiment of the present disclosure;

FIGS. 7A and 7B are diagrams each illustrating an example of a setting screen according to a second embodiment of the present disclosure;

FIG. 8 is a flowchart illustrating an example of control according to a third embodiment of the present disclosure;

FIG. 9 is a diagram illustrating an example of operation for taking out a second tray by a user according to the third embodiment of the present disclosure;

FIG. 10 is a block diagram illustrating a functional configuration of a stacker according to a fourth embodiment of the present disclosure;

FIG. 11 is a flowchart illustrating an example of control according to the fourth embodiment of the present disclosure;

FIG. 12 is a diagram illustrating an example of a function and display of availability of taking out by the user according to the fourth embodiment of the present disclosure;

FIG. 13 is a diagram illustrating an example of a notification screen when a function is set to be enabled of automatic external ejection processing according to a fifth embodiment of the present disclosure;

FIG. 14 is a diagram illustrating an example of the notification screen when the function is set to be disabled of the automatic external ejection processing according to the fifth embodiment of the present disclosure;

FIG. 15 is a flowchart illustrating an example of control according to the fifth embodiment of the present disclosure;

FIG. 16 is a flowchart illustrating an example of control according to a sixth embodiment of the present disclosure;

FIG. 17 is a diagram illustrating an example of a system configuration according to a seventh embodiment of the present disclosure; and

FIGS. 18A and 18B are diagrams each illustrating an example of a setting screen according to the seventh embodiment of the present disclosure.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

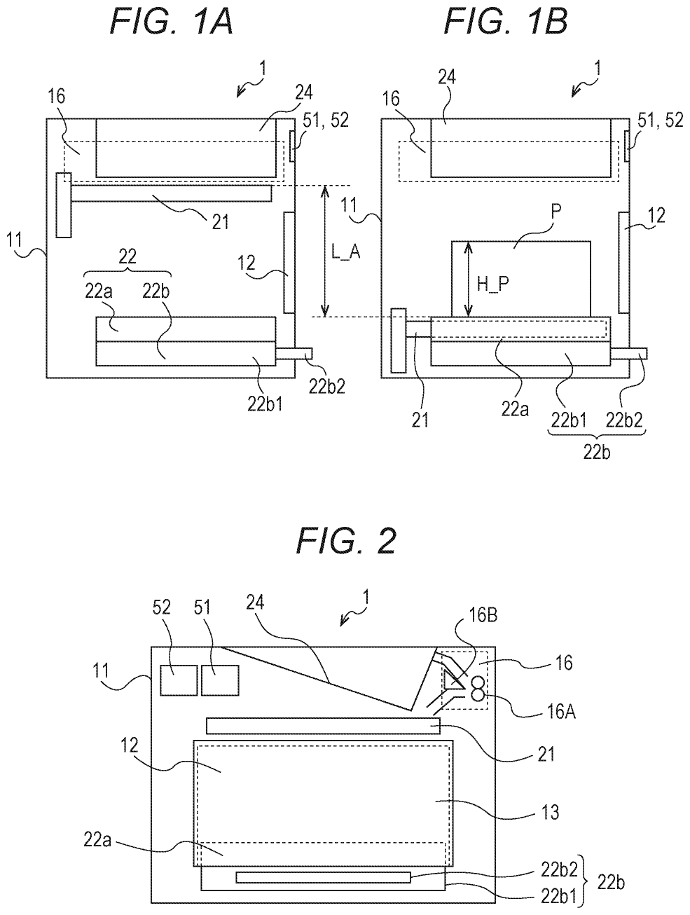

FIGS. 1A and 1B are left side views of a stacker 1 according to a first embodiment of the present disclosure. The stacker 1 includes an ejector 16, a first tray 21, a second tray 22, a sub tray 24, and the like. The ejector 16 ejects a sheet P on which an image is formed depending on a print job to an ejection destination. The ejection destination of the sheet P by the ejector 16 is either one of the first tray 21 or the sub tray 24. On the first tray 21, as the ejection destination, the sheet P ejected by the ejector 16 is stacked. The second tray 22 is a delivery destination of the sheet P stacked on the first tray 21 and with which automatic external ejection processing is executable that ejects the sheet P externally. The second tray 22 includes a temporary placement tray 22a and an eject tray 22b. The eject tray 22b includes a base 22b1 and a handle 22b2. On the sub tray 24, the sheet P ejected by the ejector 16 is stacked when operation is executed in which the sheet P stacked on the first tray 21 is delivered to the second tray 22. The first tray 21 is provided above the second tray 22, and is lowered toward the second tray 22 when the operation is executed in which the sheet P stacked on the first tray 21 is delivered to the second tray 22. Note that, a notifier 51 and a setter 52 are provided on a side surface of a housing 11. The notifier 51 includes, for example, a liquid crystal display, and performs notification of an operation procedure of the second tray 22. The setter 52 accepts a setting detail in which it is set whether or not to execute the automatic external ejection processing executable with the second tray 22. Note that, details of the notifier 51 and the setter 52 will be described later.

The sub tray 24 is provided above the first tray 21 and in the upper portion of the housing 11. To prevent increasing in size and complication of a machine, the sub tray 24 does not have a function of aligning the sheets P. Since it is assumed that the sheets P ejected to the sub tray 24 is to be piled on the sheets P ejected to the first tray 21, the sheets P stacked on the sub tray 24 are preferably in an aligned state to some extent when the sheets P are moved by a user. Thus, the number of sheets P ejected to the sub tray 24 is preferably as small as possible. The number of sheets P ejected to the sub tray 24 changes depending on a basis weight or a thickness of the sheet P. FIG. 1A illustrates an example of a state in which: a sheet reception start position that is a position at which reception of the sheet P ejected by the ejector 16 is started, is set to the uppermost position in a movement range of the first tray 21 and the uppermost surface of the first tray 21; the sheet P is not stacked on any of the first tray 21 or the sub tray 24; and the sheet P is not delivered to the second tray 22. FIG. 1B illustrates an example of a state in which: the first tray 21 is positioned at a sheet delivery position to the second tray 22; and the first tray 21 on which the sheet P is stacked is lowered to the second tray 22. Thus, a distance L_A indicates a distance from the sheet reception start position to the sheet delivery position. In FIG. 1B, a stacking height H_P of the sheets P stacked on the first tray 21 is determined based on a limit number of stacked sheets and the thickness of the sheet.

Note that, although a stacking amount of the sheets P corresponding to the limit number of stacked sheets is set to be smaller than the distance L_A, when a print job is set in which the limit number of stacked sheets is exceeded, that is, the stacking height H_P exceeds the stacking amount of the sheets P corresponding to the limit number of stacked sheets, control is executed for ejecting a bundle of the sheets P out of the stacker 1 in the middle of the print job. The control for ejecting the bundle of the sheets P will be described with reference to FIGS. 2 to 4. FIG. 2 is a front view of the stacker 1 according to the first embodiment of the present disclosure. As illustrated in FIG. 2, the ejector 16 includes an ejection roller 16A and a switching unit 16B. The ejection roller 16A ejects the sheet P. The switching unit 16B is provided on the subsequent-stage side of the ejection roller 16A, and switches ejection destinations of the sheet P ejected by the ejection roller 16A. Since a shutter 12 enables, by opening, the second tray 22 to move externally from an opening 13 provided on the front side of the housing 11, the bundle of the sheets P delivered to the second tray 22 can be ejected externally. Specifically, when the shutter 12 opens, the eject tray 22b, together with the temporary placement tray 22a, ejects the sheet P temporarily placed on the temporary placement tray 22a externally.

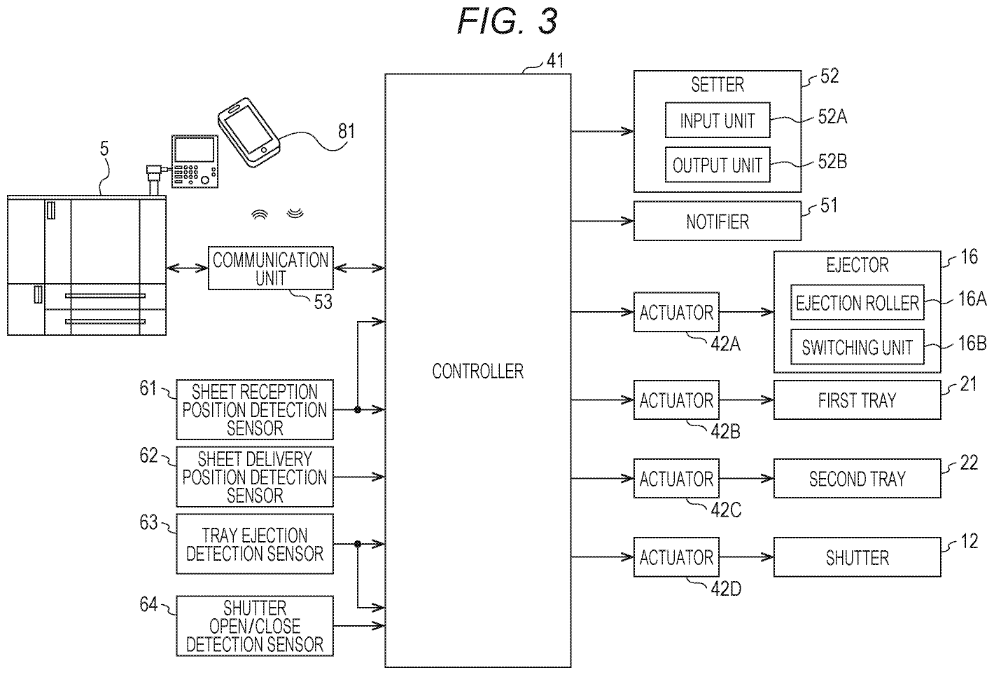

FIG. 3 is a block diagram illustrating a functional configuration of the stacker 1 according to the first embodiment of the present disclosure. The stacker 1 includes a controller 41. The controller 41 includes a CPU, an ASIC, firmware, or the like, and a memory, and various types of control are executed. The stacker 1 includes a sheet reception position detection sensor 61, a sheet delivery position detection sensor 62, a tray ejection detection sensor 63, a shutter open/close detection sensor 64, and the like. The sheet reception position detection sensor 61 detects whether or not a position of the first tray 21 is arranged at a sheet reception position, is arranged around the sheet reception position, and is formed by, for example, a photoelectric sensor. The sheet delivery position detection sensor 62 detects whether or not the position of the first tray 21 is arranged at the sheet delivery position, is arranged around the sheet delivery position, and is formed by, for example, a photoelectric sensor. The tray ejection detection sensor 63 detects whether or not the second tray 22 is ejected externally, depending on a position of the eject tray 22b, is arranged below or around the eject tray 22b, and is formed by, for example, a photoelectric sensor. The shutter open/close detection sensor 64 detects an open/close state of the shutter 12, is provided around the opening 13, and is formed by, for example, a photoelectric sensor.

The controller 41 controls an actuator 42A. Specifically, the controller 41 controls the ejector 16 with the actuator 42A, based on various types of control by a device or the like provided on the preceding-stage side of the stacker 1. The controller 41 controls an actuator 42B. Specifically, the controller 41 controls the position of the first tray 21 with the actuator 42B, based on detection results of the sheet reception position detection sensor 61 and the sheet delivery position detection sensor 62. The controller 41 controls an actuator 42C including, for example, a drive motor. Specifically, the controller 41 controls a position of the second tray 22 by controlling the position of the eject tray 22b with the actuator 42C, based on a detection result of the tray ejection detection sensor 63. That is, the actuator 42C moves the second tray 22 externally. The controller 41 controls an actuator 42D. Specifically, the controller 41 controls a position of the shutter 12 with the actuator 42D, based on a detection result of the shutter open/close detection sensor 64. Note that, when the actuator 42A, the actuator 42B, the actuator 42C, and the actuator 42D are collectively referred to, the actuators are referred to as an actuator 42.

The setter 52 includes an input unit 52A and an output unit 52B. The input unit 52A includes, for example, a touch panel. The output unit 52B includes, for example, a liquid crystal display. That is, the setter 52 functions as a liquid crystal display with a touch panel. The controller 41 controls whether or not to execute the automatic external ejection processing depending on the setting detail accepted by the setter 52, when the sheet P satisfies a target condition in which the sheet P becomes a target sheet of the automatic external ejection processing. The controller 41 continues stacking of the sheet P on the first tray 21 when not executing the automatic external ejection processing. The controller 41 executes the automatic external ejection processing, when the sheet P satisfies the target condition due to an execution detail of the print job and a function of the automatic external ejection processing is set to be enabled. Note that, the target condition includes a variable condition and a fixed condition. The variable condition is a parameter relating to the print job and is determined based on at least one of the number of jobs, the number of copies, the number of printed pages, the sheet size, the basis weight, or the sheet type. That is, when there is at least some different element between the sheet P fed already to the stacker 1 and the sheet P fed thereafter to the stacker 1, that is, when the sheets P whose conditions are different before and after feeding to the stacker 1 are fed to the stacker 1, the sheet P satisfies the target condition in which the sheet P becomes the target sheet of the automatic external ejection processing. For example, if the sheet size and basis weight of the sheet P are different before and after the sheet feeding, when the sheets having the same size and basis weight are collectively ejected externally, the sheets P fed from the image forming apparatus 5 can be divided and managed, and consistency can be maintained of the stacked sheets P.

On the other hand, the fixed condition is determined based on specifications of the first tray 21 and the second tray 22. For example, the one determined based on the specifications of the first tray 21 and the second tray 22 includes the limit number of stacked sheets described above. Thus, it is sufficient that a full count number for an upper limit count is set based on the limit number of stacked sheets. The controller 41 determines that the sheet P is the target sheet when at least one of the variable condition or the fixed condition is satisfied. Note that, a communication unit 53 communicates with a device such as a smartphone 81 or the like, or a remote controller. For example, control may be performed of execution of the automatic external ejection processing, from the device such as the smartphone 81 or the like, or the remote controller. In addition, the communication unit 53 communicates with the image forming apparatus 5. Details of the image forming apparatus 5 will be described later.

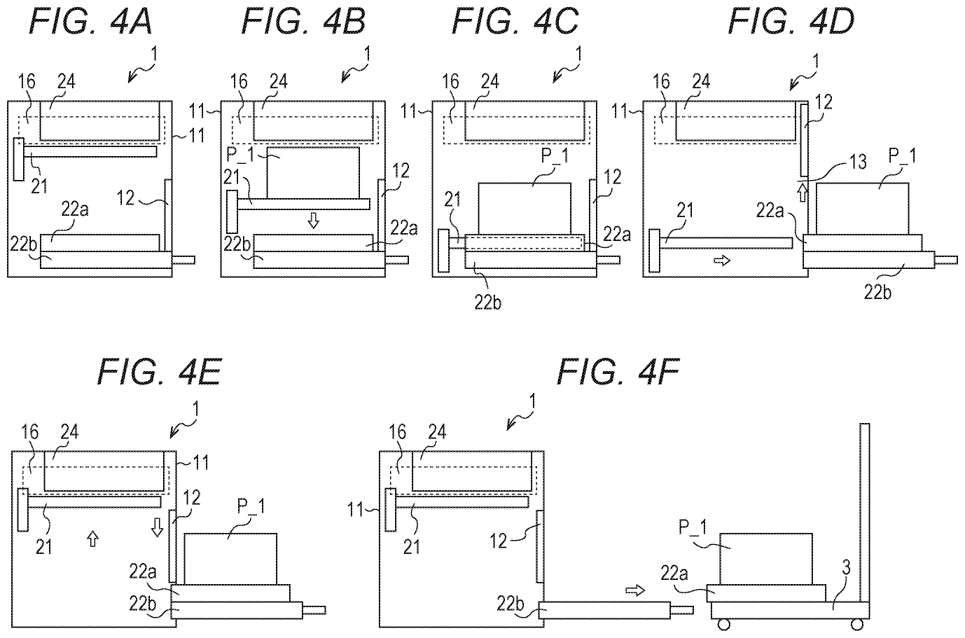

FIGS. 4A to 4F are left side views illustrating a change in the position of the first tray 21 according to the first embodiment of the present disclosure. In FIG. 4A, the first tray 21 is arranged at the sheet reception start position at which the reception of the sheet P ejected by the ejector 16 is started. In this case, the first tray 21 starts the stacking of the sheet P ejected by the ejector 16 from the sheet reception start position. Thus, the ejection destination of the sheet P by the ejector 16 is set to the first tray 21. In FIG. 4B, lowering of the first tray 21 is started. The first tray 21 is lowered toward the second tray 22 when the ejection destination of the sheet P by the ejector 16 is switched to the sub tray 24, but regarding the timing, to maintain productivity without interruption, it is necessary to consider the stacking height H_P as illustrated in FIGS. 1A and 1B and a tray movement time. Specifically, for the first tray 21, a timing of being lowered toward the second tray 22 is set, based on a timing at which the stacking amount of the sheets P ejected by the ejector 16 reaches a threshold stacking amount, and the tray movement time required to return after leaving the sheet reception start position. Such timing is adjusted depending on the basis weight or the thickness of the sheet P ejected by the ejector 16. Note that, if the stacking amount of the sheets P ejected by the ejector 16 does not reach the threshold stacking amount, it is sufficient that the timing is set at which the first tray 21 is lowered toward the second tray 22, based on a timing at which the job ends, and the time required to return after leaving the sheet reception start position.

In FIG. 4C, the first tray 21 has reached the sheet delivery position. Note that, a structure of each of the first tray 21 and the second tray 22 is formed in, for example, a comb shape. With such a configuration, the bundle of the sheets P stacked on the first tray 21 can be delivered to the second tray 22 as it is. In FIG. 4D, the shutter 12 moves upward, whereby the opening 13 is opened, and the sheets P temporarily placed on the temporary placement tray 22a are ejected out of the stacker 1 by the eject tray 22b. As a result, the sheets P_1 delivered to the second tray 22 is ejected externally. In FIG. 4E, the shutter 12 is lowered halfway, whereby a part of the opening 13 is closed and the first tray 21 returns to the sheet reception start position. When the first tray 21 returns to the sheet reception start position and is arranged at the sheet reception position in this way, the ejector 16 stops the ejection to the sub tray 24 and switches the ejection destination to the first tray 21. That is, the ejector 16 sets the sub tray 24 as the ejection destination during a period from when the first tray 21 leaves the sheet reception start position due to the delivery to the second tray 22 and then returns. In FIG. 4F, the second tray 22 is moved to a cart 3.

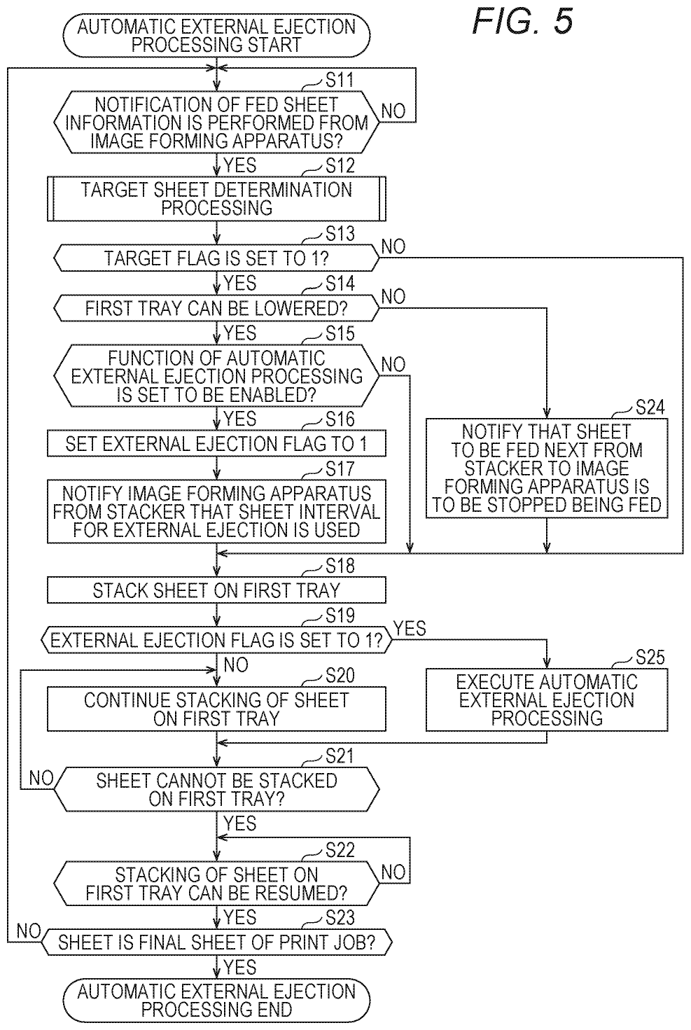

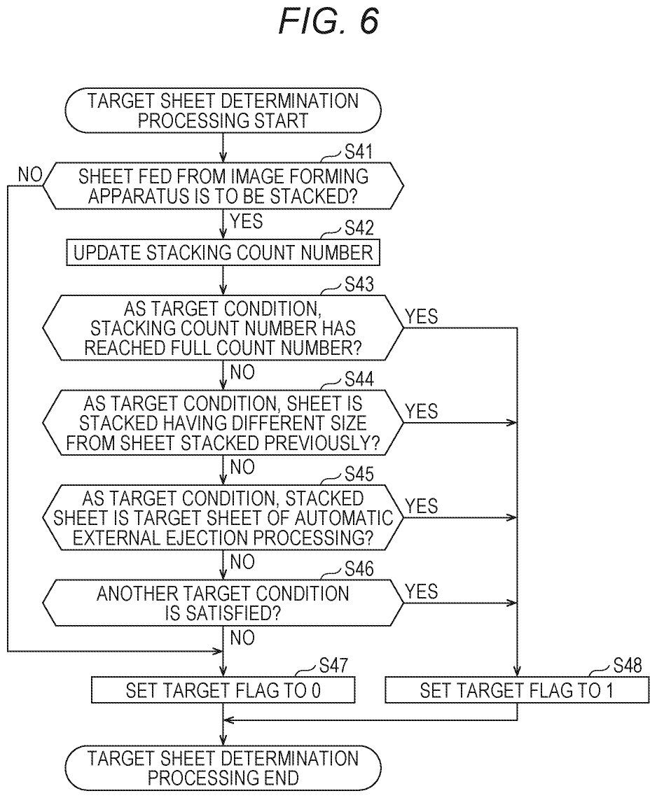

FIG. 5 is a flowchart illustrating the automatic external ejection processing according to the first embodiment of the present disclosure. Note that, it is assumed that various flags are initialized before the processing of step S11. In step S11, the controller 41 determines whether or not the controller 41 is notified of fed sheet information from the image forming apparatus 5. When it is determined that the controller 41 is notified of the fed sheet information from the image forming apparatus 5 (step S11; Y), the controller 41 proceeds to the processing of step S12. When it is determined that the controller 41 is not notified of the fed sheet information from the image forming apparatus 5 (step S11; N), the controller 41 continues the processing of step S11. In step S12, target sheet determination processing is executed. Note that, details of the target sheet determination processing will be described later with reference to FIG. 6. In step S13, the controller 41 determines whether or not a target flag is set to 1. When it is determined that the target flag is set to 1 (step S13; Y), the controller 41 proceeds to the processing of step S14. When it is determined that the target flag is not set to 1 (step S13; N), the controller 41 proceeds to the processing of step S18. In step S14, the controller 41 determines whether or not the first tray 21 can be lowered. When it is determined that the first tray 21 can be lowered (step S14; Y), the controller 41 proceeds to the processing of step S15. When it is determined that the first tray 21 cannot be lowered (step S14; N), the controller 41 proceeds to the processing of step S24. In step S24, the controller 41 notifies that the sheet P to be fed next from the stacker 1 to the image forming apparatus 5 is to be stopped being fed, and proceeds to the processing of step S18.

In step S15, the controller 41 determines whether or not the function of the automatic external ejection processing is set to be enabled. When it is determined that the function of the automatic external ejection processing is set to be enabled (step S15; Y), the controller 41 proceeds to the processing of step S16. In step S16, the controller 41 sets an external ejection flag to 1, and in step S17, the controller 41 notifies the image forming apparatus 5 from the stacker 1 that a sheet interval for external ejection is used, and proceeds to the processing of step S18. When it is determined that the function of the automatic external ejection processing is not set to be enabled (step S15; N), the controller 41 proceeds to the processing of step S18. In step S18, the controller 41 stacks the sheets P on the first tray 21. In step S19, the controller 41 determines whether or not the external ejection flag is set to 1. When it is determined that the external ejection flag is set to 1 (step S19; Y), the controller 41 proceeds to the processing of step S25, and in step S25, the controller 41 executes the automatic external ejection processing, and proceeds to the processing of step S21. The automatic external ejection processing is a sequential operation of operation of delivering the sheets P stacked on the first tray 21 to the second tray 22, and operation of ejecting the sheets P delivered to the second tray 22 externally. When it is determined that the external ejection flag is not set to 1 (step S19; N), the controller 41 proceeds to the processing of step S20, and in step S20, the controller 41 continues the stacking of the sheet P on the first tray 21, and proceeds to the processing of step S21.

In step S21, the controller 41 determines whether or not the sheets P cannot be stacked on the first tray 21. When it is determined that the sheets P cannot be stacked on the first tray 21 (step S21; Y), the controller 41 proceeds to the processing of step S22. When it is determined that the sheets P can be stacked on the first tray 21 (step S21; N), the controller 41 returns to the processing of step S20. In step S22, the controller 41 determines whether or not the stacking of the sheet P on the first tray 21 can be resumed. When it is determined that the stacking of the sheet P on the first tray 21 can be resumed (step S22; Y), the controller 41 proceeds to the processing of step S23. When it is determined that the stacking of the sheet P on the first tray 21 cannot be resumed (step S22; N), the controller 41 continues the processing of step S22. In step S23, the controller 41 determines whether or not the sheet P is the final sheet of the print job. When it is determined that the sheet P is the final sheet of the print job (step S23; Y), the controller 41 ends the automatic external ejection processing. When it is determined that the sheet P is not the final sheet of the print job (step S23; N), the controller 41 returns to the processing of step S11.

FIG. 6 is a flowchart illustrating the target sheet determination processing according to the first embodiment of the present disclosure. In step S41, the controller 41 determines whether or not the sheet P fed from the image forming apparatus 5 is to be stacked. When it is determined that the sheet P fed from the image forming apparatus 5 is to be stacked (step S41; Y), the controller 41 proceeds to the processing of step S42. When it is determined that the sheet P fed from the image forming apparatus 5 is not to be stacked (step S41; N), the controller 41 proceeds to the processing of step S47. In step S42, the controller 41 updates a stacking count number. The stacking count number is, for example, incremented by +1. In step S43, the controller 41 determines, as a target condition, whether or not the stacking count number has reached the full count number. If the limit number of stacked sheets is set as the full count number, it is sufficient that the stacking count number is incremented by +1. Note that, the full count number may be set for each number of copies with reference to the print job. When it is determined, as the target condition, that the stacking count number has reached the full count number (step S43; Y), the controller 41 proceeds to the processing of step S48. When it is determined, as the target condition, that the stacking count number has not reached the full count number (step S43; N), the controller 41 proceeds to the processing of step S44. In step S44, the controller 41 determines, as the target condition, whether or not the sheet P is stacked having a different size from the sheet P stacked previously. By the processing of step S44, stacking can be prohibited of the sheet P having at least some different element such as the size. When it is determined, as the target condition, that the sheet P is stacked having the different size from the sheet P stacked previously (step S44; Y), the controller 41 proceeds to the processing of step S48. When it is determined, as the target condition, that the sheet P is not stacked having the different size from the sheet P stacked previously (step S44; N), the controller 41 proceeds to the processing of step S45.

In step S45, the controller 41 determines, as the target condition, whether or not the stacked sheet P is the target sheet of the automatic external ejection processing. For example, it is determined, as the target condition, whether or not the basis weight of the sheet P is applicable. When it is determined, as the target condition, that the stacked sheet P is the target sheet of the automatic external ejection processing (step S45; Y), the controller 41 proceeds to the processing of step S48. When it is determined, as the target condition, that the stacked sheet P is not the target sheet of the automatic external ejection processing (step S45; N), the controller 41 proceeds to the processing of step S46. In step S46, the controller 41 determines whether or not another target condition is satisfied. As the other target condition, for example, it is determined whether or not the sheet type of the sheet P is applicable. When it is determined that the other target condition is satisfied (step S46; Y), the controller 41 proceeds to the processing of step S48. When it is determined that the other target condition is not satisfied (step S46; N), the controller 41 proceeds to the processing of step S47. In step S47, the controller 41 sets the target flag to 0, and ends the target sheet determination processing. That is, it is determined by the processing of step S47 that the sheet P is not the target sheet of the automatic external ejection processing. In step S48, the controller 41 sets the target flag to 1, and ends the target sheet determination processing. That is, it is determined by the processing of step S48 that the sheet P is the target sheet of the automatic external ejection processing. Note that, although an example has been described in which the processing of steps S43 to S46 is sequentially executed, any of them may be executed first or may be executed in parallel. For example, the processing may be executed in the order of step S45, step S46, step S43, and step S44, or part or all of step S43, step S44, step S45, and step S46 may be executed simultaneously.

From the above description, in the first embodiment, it is controlled whether or not to execute the automatic external ejection processing, depending on the setting detail, when the sheet P satisfies the target condition in which the sheet P becomes the target sheet of the automatic external ejection processing. Thus, even if the sheet P satisfies the target condition, the automatic external ejection processing is not executed depending on the setting detail. In addition, when the automatic external ejection processing is not executed, the stacking of the sheet P on the first tray 21 is continued. Therefore, maintenance of productivity and improvement of security can be implemented.

In addition, in the first embodiment, it is determined that the sheet P is the target sheet of the automatic external ejection processing when at least one of the variable condition or the fixed condition is satisfied. Thus, determination can be performed whether or not the sheet is the target sheet of the automatic external ejection processing depending on the print job, print medium, stacking environment, and the like. Therefore, setting can be performed of the automatic external ejection processing suitable for situations.

In addition, in the first embodiment, the automatic external ejection processing is executed, when the sheet P satisfies the target condition due to the execution detail of the print job and the function of the automatic external ejection processing is set to be enabled. Thus, the automatic external ejection processing is executed based on the print job and the setting detail. The print job can specify the sheet P to be ejected, and the setting detail can specify operation of the stacker 1 from a viewpoint different from the print job. Therefore, the execution of the automatic external ejection processing can be started from a multifaceted viewpoint.

### Second Embodiment

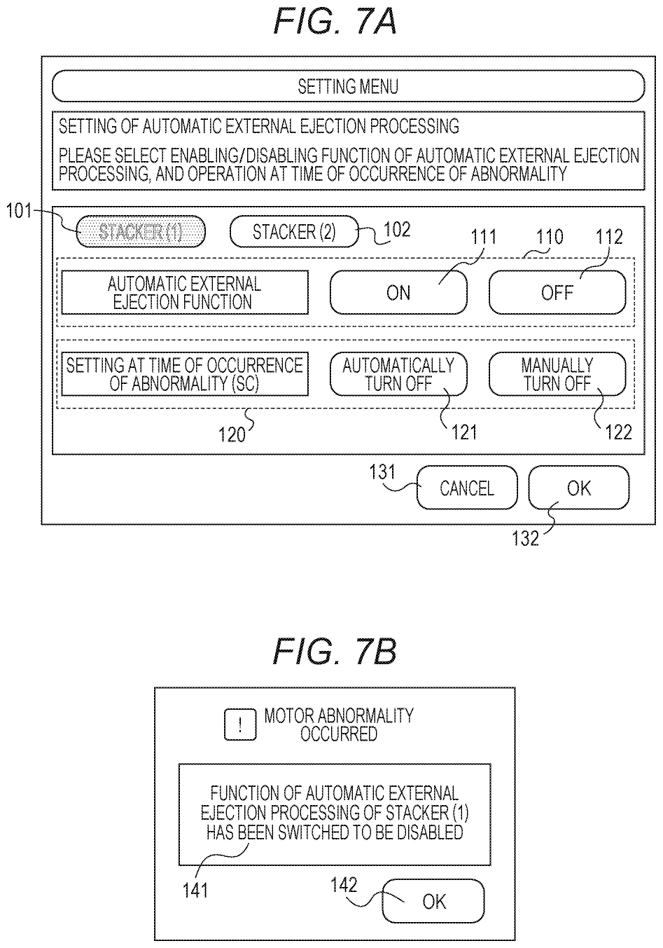

In a second embodiment, the configuration and function of the stacker 1 are similar to those in the first embodiment, and thus the description thereof will be omitted. In the second embodiment, the setting detail accepted by the setter 52 will be specifically described. FIGS. 7A and 7B are diagrams each illustrating an example of a setting screen according to the second embodiment of the present disclosure. In the example of FIG. 7A, for each of a stacker (1) and a stacker (2), it is possible to set the function of the automatic external ejection processing and operation at the time of occurrence of an abnormality. For example, the stacker (1) designated by operation of a button 101 is corresponds to the stacker 1, and the stacker (2) designated by a button 102 corresponds to one other than the stacker 1. The setting detail includes a default setting and an exception setting. The default setting sets the function of the automatic external ejection processing to be either enabled or disabled, and for example, can be set by a button 111 and a button 112 displayed in a default setting area 110, as illustrated in FIGS. 7A and 7B.

The exception setting sets the function of the automatic external ejection processing to be disabled when an abnormality occurs internally, and for example, can be set by a button 121 and a button 122 displayed in an exception setting area 120, as illustrated in FIGS. 7A and 7B. The exception setting is a condition set depending on whether or not the actuator 42C is in an abnormal state. Thus, the controller 41 controls the actuator 42C, based on the exception setting. Operation details of the button 111, the button 112, the button 121, and the button 122 are canceled by a button 131, and approved by a button 132. For example, in FIG. 7A, when the button 101, the button 121, and the button 132 are operated, the setting screen changes to a screen as illustrated in FIG. 7B. In the screen of FIG. 7B, a notification detail is displayed in a notification area 141, and can be ended by a button 142. Note that, the exception setting takes precedence over the default setting.

From the above description, in the second embodiment, out of the setting details, the exception setting takes precedence over the default setting. Thus, even if the function of the automatic external ejection processing is set to be enabled by the default setting, the function of the automatic external ejection processing is set to be disabled when the abnormality occurs internally. Therefore, when the automatic external ejection processing cannot be executed, a malfunction can be prevented by stopping the execution of the automatic external ejection processing.

In addition, in the second embodiment, the second tray 22 is controlled based on the exception setting. Thus, when the abnormality occurs internally, the exception setting is applied to the control of the second tray 22.

Therefore, when the automatic external ejection processing of the second tray 22 is not suitable, external ejection of the second tray 22 can be avoided.

### Third Embodiment

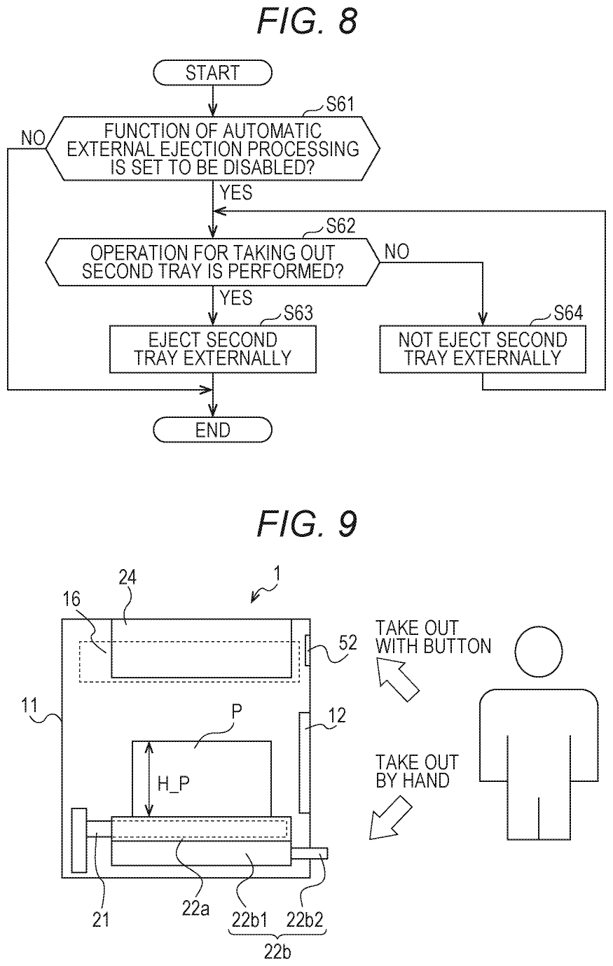

In a third embodiment, the configuration and function of the stacker 1 are similar to those in the first and second embodiments, and thus the description thereof will be omitted. In the third embodiment, processing will be specifically described in a case where the function of the automatic external ejection processing is set to be disabled. FIG. 8 is a flowchart illustrating an example of control according to the third embodiment of the present disclosure. In step S61, the controller 41 determines whether or not the function of the automatic external ejection processing is set to be disabled. When it is determined that the function of the automatic external ejection processing is set to be disabled (step S61; Y), the controller 41 proceeds to the processing of step S62. When it is determined that the function of the automatic external ejection processing is not set to be disabled (step S61; N), the controller 41 ends the processing. In step S62, the controller 41 determines whether or not operation for taking out the second tray 22 is performed. The controller 41 determines whether or not the operation for taking out the second tray 22 is performed, depending on a detection result of the tray ejection detection sensor 63. When it is determined that the operation for taking out the second tray 22 is performed (step S62; Y), the controller 41 proceeds to the processing of step S63. In step S63, the controller 41 ejects the second tray 22 externally, and ends the processing. When it is determined that the operation for taking out the second tray 22 is not performed (step S62; N), the controller 41 proceeds to the processing of step S64. In step S64, the controller 41 does not eject the second tray 22 externally, and returns to the processing of step S62. That is, the controller 41, when the function of the automatic external ejection processing is set to be disabled, does not eject the second tray 22 externally until the operation for taking out the second tray 22 is performed, and enables external ejection of the second tray 22 after the operation for taking out the second tray 22 is performed.

FIG. 9 is a diagram illustrating an example of the operation for taking out the second tray 22 by the user according to the third embodiment of the present disclosure. When the user operates the setter 52, or when the user pulls the handle 22b2 of the second tray 22, the operation for taking out the second tray 22 can be performed. Note that, as described with reference to FIG. 3, the operation for taking out the second tray 22 may be performed with a device such as the smartphone 81 or the remote controller.

From the above description, in the third embodiment, when the function of the automatic external ejection processing is set to be disabled, the second tray 22 is not ejected externally until the operation for taking out the second tray 22 is performed, and external ejection of the second tray 22 is enabled after the operation for taking out the second tray 22 is performed. Thus, if there is no operation for taking out the second tray 22, the second tray 22 remains internally. Therefore, security can be improved. In addition, since the second tray 22 can be ejected externally by the operation for taking out the second tray 22, confidential documents and the like are not automatically taken out externally, and can be manually taken out externally when necessary. In addition, when the stacker 1 is installed in a narrow space such as a room with a small space, it is necessary to prevent the stacker 1 from getting in the way of the operator's flow line; however, the function of the automatic external ejection processing can be set to be disabled, so that the stacker 1 can be used even in such a space.

### Fourth Embodiment

In a fourth embodiment, the configuration and function of the stacker 1 are similar to those in the first to third embodiments, and thus the description thereof will be omitted. In the fourth embodiment, a constraint condition will be described that takes precedence over setting of enabling and disabling the function of automatic external ejection processing. The constraint condition constrains the operation for taking out the second tray 22. The controller 41 determines availability of the operation for taking out the second tray 22 depending on the constraint condition. The constraint condition is satisfied when the operation for taking out the second tray 22 is performed while the sheet P is stacked on the first tray 21, or when the automatic external ejection processing with the second tray 22 is executed. When the constraint condition is satisfied, the controller 41 disables the operation for taking out the second tray 22.

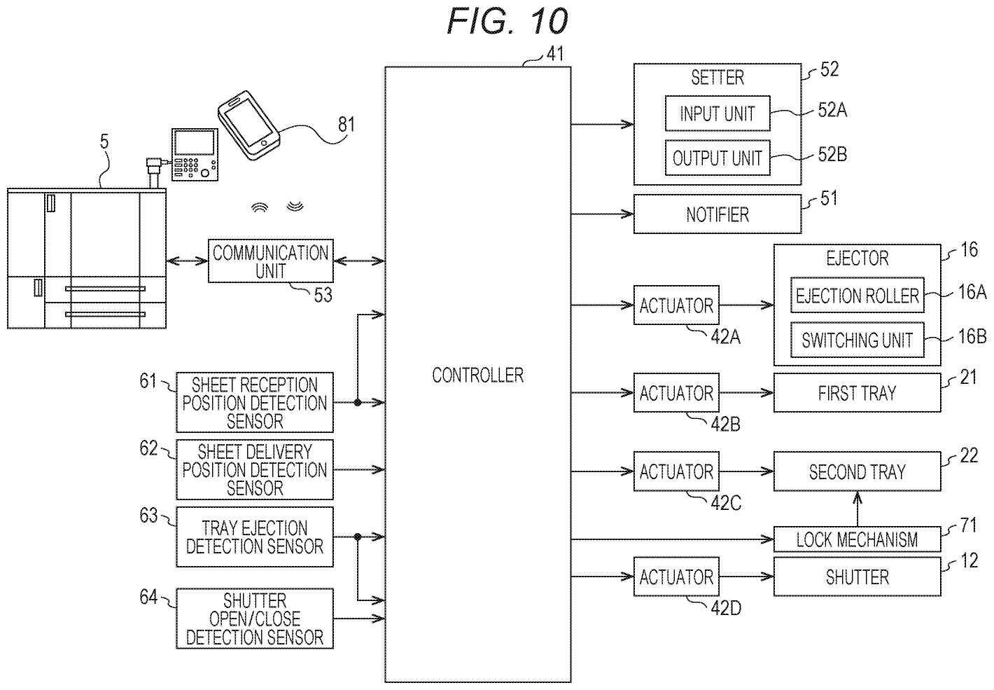

FIG. 10 is a block diagram illustrating a functional configuration of the stacker 1 according to the fourth embodiment of the present disclosure. As illustrated in FIG. 10, a lock mechanism 71 is further provided that locks the second tray 22. The controller 41, when disabling the operation for taking out the second tray 22, performs at least one operation of operation for locking the second tray 22 with the lock mechanism 71, operation for stopping of a function relating to execution of the print job at the time of detecting the operation for taking out the second tray 22, or operation for changing the notification detail with the notifier 51.

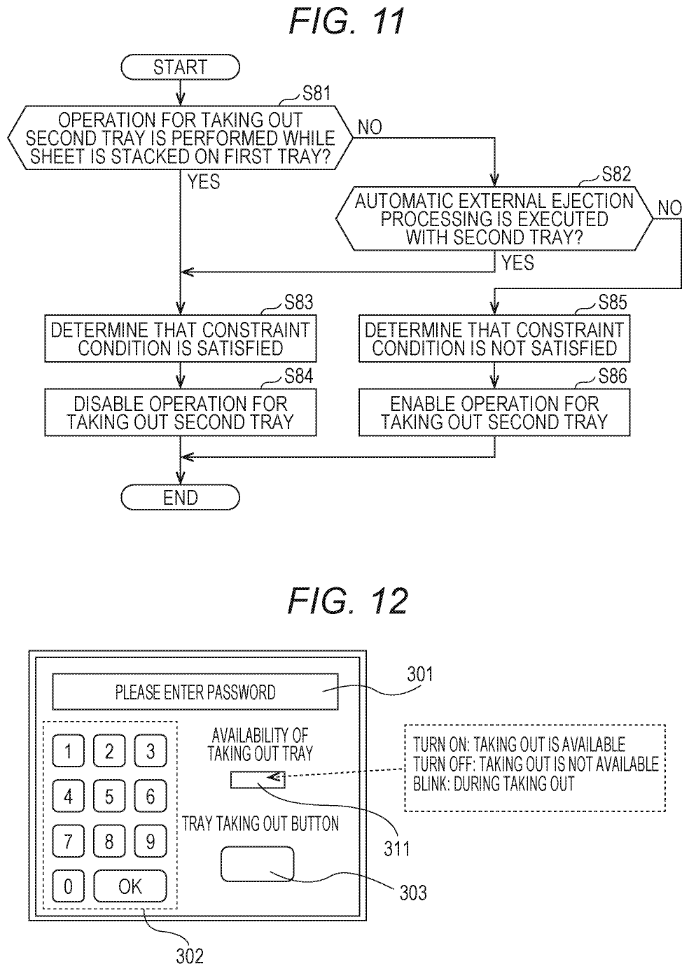

FIG. 11 is a flowchart illustrating an example of control according to the fourth embodiment of the present disclosure. In step S81, the controller 41 determines whether or not the operation for taking out the second tray 22 is performed while the sheet P is stacked on the first tray 21. When it is determined that the operation for taking out the second tray 22 is performed while the sheet P is stacked on the first tray 21 (step S81; Y), the controller 41 proceeds to the processing of step S83. When it is determined that the operation for taking out the second tray 22 is not performed while the sheet P is stacked on the first tray 21 (step S81; N), the controller 41 proceeds to the processing of step S82. In step S82, the controller 41 determines whether or not the automatic external ejection processing with the second tray 22 is executed. When it is determined that the automatic external ejection processing with the second tray 22 is executed (step S82; Y), the controller 41 proceeds to the processing of step S83. In step S83, the controller 41 determines that the constraint condition is satisfied, and proceeds to the processing of step S84. In step S84, the controller 41 disables the operation for taking out the second tray 22, and ends the processing. On the other hand, when it is determined that the automatic external ejection processing with the second tray 22 is not executed (step S82; N), the controller 41 proceeds to the processing of step S85. In step S85, the controller 41 determines that the constraint condition is not satisfied, and proceeds to the processing of step S86. In step S86, the controller 41 enables the operation for taking out the second tray 22, and ends the processing.

FIG. 12 is a diagram illustrating an example of a function and display of availability of taking out by the user according to the fourth embodiment of the present disclosure. In the example of FIG. 12, an operation result of an operation key 302 including a numeric keypad and the like is displayed in an input display field 301. A notification lamp 311 indicates availability of taking out the second tray 22, and for example, has a function of notifying that the second tray 22 can be taken out if the notification lamp 311 is turned on, the second tray 22 cannot be taken out if the notification lamp 311 is turned off, and the second tray 22 is being taken out if the notification lamp 311 blinks. When a password is input with the operation key 302 and the input password is correct, the operation for taking out the second tray 22 can be performed by operation of an operation button 303. Note that, the operation key 302, the operation button 303, and the notification lamp 311 may be displayed as images by the output unit 52B of the setter 52, or may be formed as hardware.

From the above description, in the fourth embodiment, the availability of the operation for taking out the second tray 22 is determined depending on the constraint condition. Thus, the operation for taking out the second tray 22 is disabled depending on the constraint condition. Therefore, it can be avoided that the operation for taking out the second tray 22 is performed at an inappropriate timing.

In addition, in the fourth embodiment, when the constraint condition is satisfied, the operation for taking out the second tray 22 is disabled. The operation for taking out the second tray 22 is operation for physically taking out the second tray 22 by the user. Thus, while the automatic external ejection processing is performed with the second tray 22, if the operation for taking out the second tray 22 is prohibited, no fault occurs. In addition, since the operation of the second tray 22 by the user is manual operation, a risk of alignment collapse of the sheets P or the damage of the sheets P is increased as compared with the ejection operation of the second tray 22 with the actuator 42C. Thus, when such a situation is assumed, such a risk can be avoided by providing the constraint condition. Therefore, the operation for taking out the second tray 22 can be performed under appropriate situations.

In addition, in the fourth embodiment, when the operation for taking out the second tray 22 is disabled, at least one operation is performed of the operation for locking the second tray 22 with the lock mechanism 71, the operation for stopping of the function relating to execution of the print job at the time of detecting the operation for taking out the second tray 22, or the operation for changing the notification detail with the notifier 51. Thus, the fault can be prevented from being caused in the consistency and the quality of the machine and the printed matter. Therefore, the ejection operation of the sheet P can be performed while the sheet P is maintained at high quality.

### Fifth Embodiment

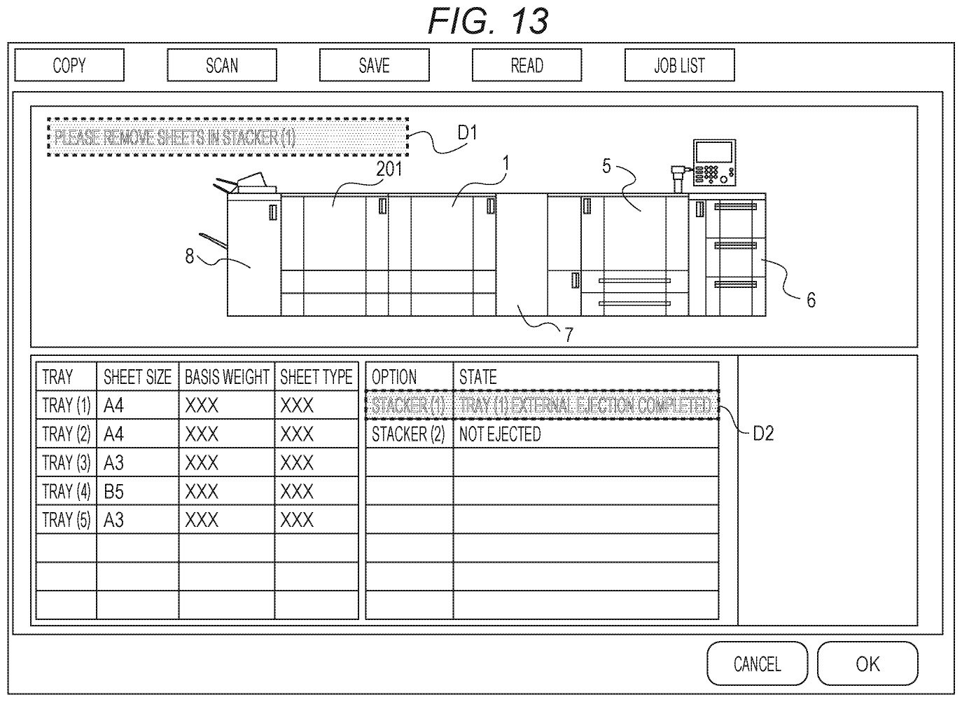

In a fifth embodiment, the configuration and functions of the stacker 1 are similar to those in the first to fourth embodiments, and thus the description thereof will be omitted. In the fifth embodiment, the notification detail of the notifier 51 will be specifically described. The notifier 51 changes the notification detail of the operation procedure of the second tray 22, depending on whether the function of the automatic external ejection processing is set to be enabled or disabled. FIG. 13 is a diagram illustrating an example of a notification screen when the function is set to be enabled of the automatic external ejection processing according to the fifth embodiment of the present disclosure. In the example illustrated in FIG. 13, an image forming system is displayed including a sheet feeding apparatus 6, the image forming apparatus 5, a relay apparatus 7, the stacker 1, a stacker 201, and a finisher 8. The image forming apparatus 5 is connected to the subsequent-stage side of the sheet feeding apparatus 6, the relay apparatus 7 is connected to the subsequent-stage side of the image forming apparatus 5, the stacker 1 is connected to the subsequent-stage side of the relay apparatus 7, the stacker 201 is connected to the subsequent-stage side of the stacker 1, and the finisher 8 is connected to the subsequent-stage side of the stacker 201.

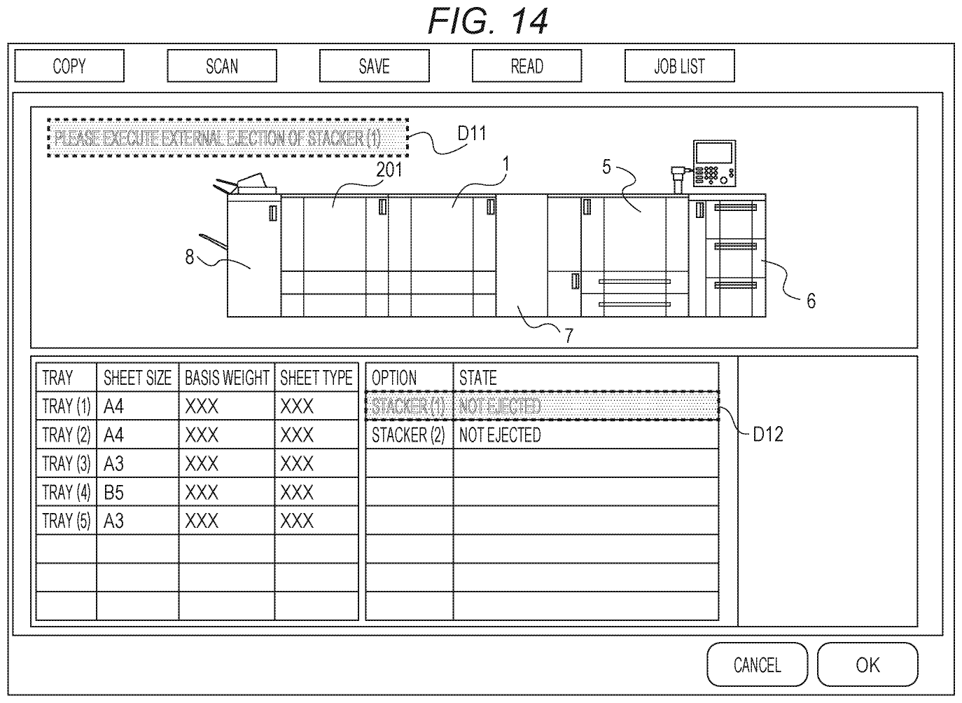

The relay apparatus 7 accelerates conveyance of the sheet P fed from the image forming apparatus 5. The stacker 201 has the same configuration and function as those of the stacker 1, and thus the description thereof will be omitted. Note that, in FIG. 13, the stacker (1) corresponds to the stacker 1, and the stacker (2) corresponds to the stacker 201. In a notification area D1, notification is performed of guidance for the user, and in a notification area D2, notification is performed of a state of the stacker 1. Specifically, in the example of FIG. 13, since the function of the automatic external ejection processing of the stacker 1 is set to be enabled, when the ejection of the sheet P is completed, the bundle of the sheets P exists externally. Thus, notification is performed of the fact in the notification area D2, and notification is performed, in the notification area D1, that the bundle of the sheets P ejected externally by the stacker 1 is to be removed, as operation to be performed by the user. FIG. 14 is a diagram illustrating an example of the notification screen when the function is set to be disabled of the automatic external ejection processing according to the fifth embodiment of the present disclosure. In the example of FIG. 14, in an image forming system similar to that of FIG. 13, since the function of the automatic external ejection processing of the stacker 1 is set to be disabled, the sheet P is not ejected externally. Thus, notification is performed of the fact in the notification area D12, and notification is performed, in the notification area D11, that external ejection from the stacker 1 is to be manually performed, as operation to be performed by the user.

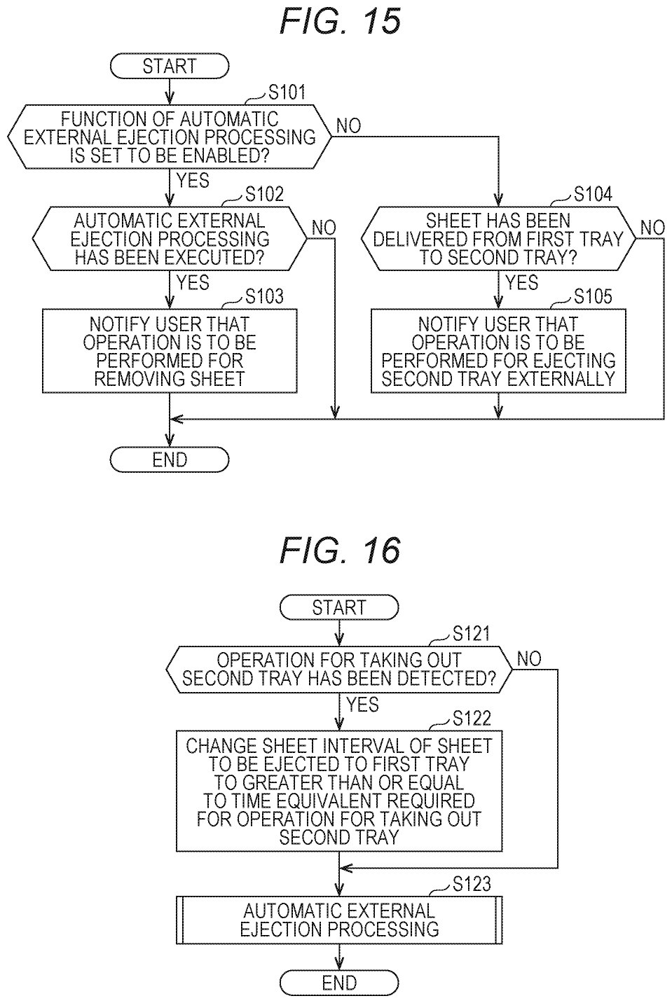

FIG. 15 is a flowchart illustrating an example of control according to the fifth embodiment of the present disclosure. In step S101, the controller 41 determines whether or not the function of the automatic external ejection processing is set to be enabled. When it is determined that the function of the automatic external ejection processing is set to be enabled (step S101; Y), the controller 41 proceeds to the processing of step S102. In step S102, the controller 41 determines whether or not the automatic external ejection processing has been executed. When it is determined that the automatic external ejection processing has been executed (step S102; Y), the controller 41 proceeds to the processing of step S103. In step S103, the notifier 51 notifies the user that operation is to be performed for removing the sheet P, and the controller 41 ends the processing. When it is determined that the automatic external ejection processing has not been executed (step S102; N), the controller 41 ends the processing.

When it is determined that the function of the automatic external ejection processing is not set to be enabled (step S101; N), the controller 41 proceeds to the processing of step S104. In step S104, the controller 41 determines whether or not the sheet P has been delivered from the first tray 21 to the second tray 22. When it is determined that the sheet P has been delivered from the first tray 21 to the second tray 22 (step S104; Y), the controller 41 proceeds to the processing of step S105. In step S105, the notifier 51 notifies the user that operation is to be performed for ejecting the second tray 22 externally, and the controller 41 ends the processing. When it is determined that the sheet P has not been delivered from the first tray 21 to the second tray 22 (step S104; N), the controller 41 ends the processing.

From the above description, in the fifth embodiment, the notification detail of the operation procedure of the second tray 22 is changed depending on whether the function of the automatic external ejection processing is set to be enabled or disabled. The operation procedure of the second tray 22 differs between a case where the function of the automatic external ejection processing is set to be enabled and a case where the function of the automatic external ejection processing is set to be disabled. Thus, the notification detail of the operation procedure of the second tray 22 is changed depending on each setting, whereby the user can obtain appropriate guidance. Therefore, the user can be prompted for appropriate operation.

### Sixth Embodiment

In a sixth embodiment, the configuration and function of the stacker 1 are similar to those in the first to fifth embodiments, and thus the description thereof will be omitted. In the sixth embodiment, processing will be described in which the operation for taking out the second tray 22 by the user is performed when the function of the automatic external ejection processing of the second tray 22 is enabled. Specifically, a sheet interval of the sheet P to be ejected to the first tray 21 is changed to greater than or equal to a time equivalent required for the operation for taking out the second tray 22, when the function of the automatic external ejection processing is set to be enabled and the operation for taking out the second tray 22 is performed. More specifically, a timing at which the sheet P with the changed sheet interval is ejected to the first tray 21 and a timing at which the first tray 21 is lowered to the sheet delivery position and then raised to return to the sheet reception position are made to coincide with each other, or the timing at which the sheet P with the changed sheet interval is ejected to the first tray 21 is delayed compared to the timing at which the first tray 21 is lowered to the sheet delivery position and then raised to return to the sheet reception position.

FIG. 16 is a flowchart illustrating an example of control according to the sixth embodiment of the present disclosure. In step S121, the controller 41 determines whether or not the operation for taking out the second tray 22 has been detected. When it is determined that the operation for taking out the second tray 22 has been detected (step S121; Y), the controller 41 proceeds to the processing of step S122. When it is determined that the operation for taking out the second tray 22 has not been detected (step S121; N), the controller 41 proceeds to the processing of step S123. In step S122, the controller 41 changes the sheet interval of the sheet P to be ejected to the first tray 21 to greater than or equal to the time equivalent required for the operation for taking out the second tray 22. In step S123, the controller 41 executes the automatic external ejection processing, and ends the processing. The automatic external ejection processing is the processing of steps S11 to S25 described above.

From the above description, in the sixth embodiment, the sheet interval of the sheet P to be ejected to the first tray 21 is changed to greater than or equal to the time equivalent required for the operation for taking out the second tray 22, when the function of the automatic external ejection processing is set to be enabled and the operation for taking out the second tray 22 is performed. Thus, since a sufficient sheet interval of the sheet P is secured, the operation for taking out the second tray 22 is not prevented even if it is the premise that the automatic external ejection processing is executed. Therefore, even if the automatic external ejection processing is set to be executed, the sheet P can be ejected externally by the operation for taking out the second tray 22.

### Seventh Embodiment

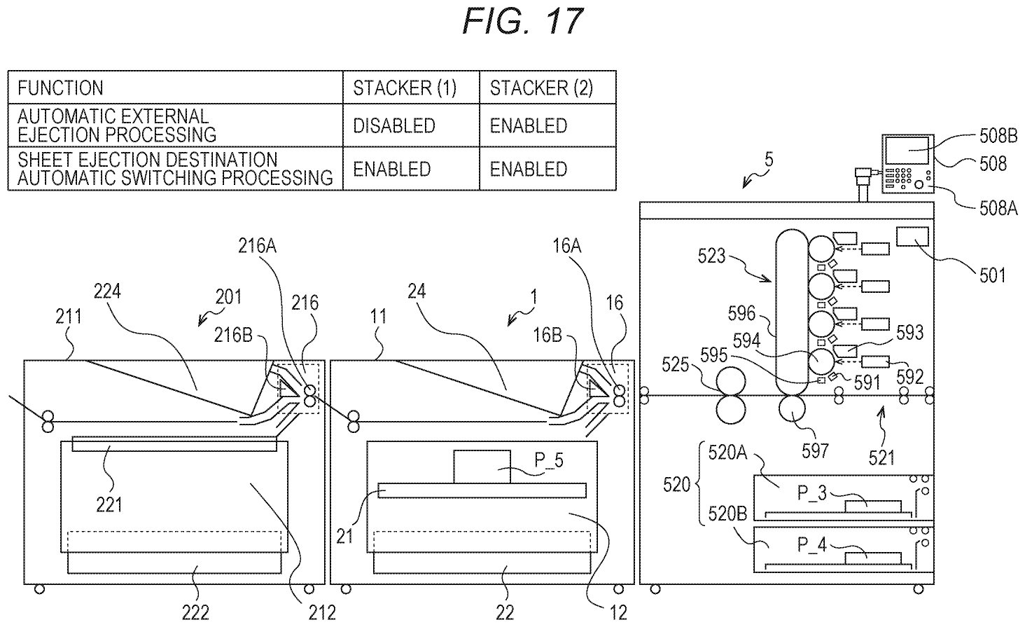

In a seventh embodiment, the configuration and function of the stacker 1 are similar to those in the first to sixth embodiments, and thus the description thereof will be omitted. In the seventh embodiment, processing will be described in which, in a configuration in which a plurality of ejection destinations is provided on the subsequent-stage side of the image forming apparatus 5, the function of the automatic external ejection processing implemented in the ejection destinations is changed from being enabled to being disabled. FIG. 17 is a diagram illustrating an example of a system configuration according to the seventh embodiment of the present disclosure. As illustrated in FIG. 17, the stacker 1 is connected to the image forming apparatus 5 on the sheet ejection side. The stacker 201 is connected to the sheet ejection side of the stacker 1, that is, the subsequent-stage side of the stacker 1. The stacker 201 has the configuration and function similar to those of the stacker 1, as described above. Specifically, the stacker 201 includes an ejector 216, a first tray 221, a second tray 222, a sub tray 224, and the like. In addition, a shutter 212 is provided in a housing 211 of the stacker 201. In addition, the ejector 216 includes an ejection roller 216A and a switching unit 216B. Thus, the detailed description of the configuration and function of the stacker 201 will be omitted. Note that, in FIG. 17, the stacker (1) corresponds to the stacker 1, and the stacker (2) corresponds to the stacker 201. Thus, as illustrated in FIG. 17, in the stacker 1, the function of the automatic external ejection processing is set to be disabled, and a function of sheet ejection destination automatic switching is set to be enabled. On the other hand, in the stacker 201, the function of the automatic external ejection processing is set to be enabled, and the function of the sheet ejection destination automatic switching is set to be enabled. That is, in the system configuration, the stacker 201 that is the subsequent-stage side ejection destination is provided on the subsequent-stage side from the first tray 21, as the ejection destination, and the stacker 201 that is the subsequent-stage side ejection destination is enabled to execute the automatic external ejection processing, and the ejection destination is switchable to either one of the first tray 21 of the stacker 1, or the first tray 221 of the stacker 201 that is the subsequent-stage side ejection destination.

The image forming apparatus 5 includes an image forming unit 523 that forms an image on the sheet P placed on a sheet feeding unit 520. A main body setting unit 508 is provided on the upper portion of the image forming apparatus 5. The main body setting unit 508 includes a main body input unit 508A and a main body output unit 508B. User's operation is accepted via the main body input unit 508A, and various types of information is displayed by the main body output unit 508B. A controller 501 includes a CPU, a ROM, a RAM, an I/O interface, and the like (not illustrated). The CPU reads a program depending on processing details from the ROM and deploys the program on the RAM, and controls operation of the image forming apparatus 5 by cooperating with the program deployed.

The image forming unit 523 is provided on a conveyance path 521 and on a conveyance direction downstream side of the sheet P. The sheet P placed on the sheet feeding unit 520 is fed out and conveyed toward the image forming unit 523. Note that, in FIG. 17, the sheet feeding unit 520 includes a sheet feeding unit 520A and a sheet feeding unit 520B. The image forming unit 523 includes photoconductors 594 respectively prepared for corresponding colors such as cyan, magenta, yellow, and black, and a charging device 591, an exposure device 592, and a developing device 593 are provided around each of the photoconductors 594.

On the surface of each of the photoconductors 594 charged by the charging device 591, an image is exposed by the exposure device 592 based on image information of a document, and an electrostatic latent image is formed. The electrostatic latent image is developed by the developing device 593 to form a toner image. The toner image is transferred to an intermediate transfer belt 596. The toner image transferred to the intermediate transfer belt 596 is transferred to the sheet P conveyed along the conveyance path 521 while being pressure-bonded by a secondary transfer roller 597. The toner image pressure-bonded and transferred by the secondary transfer roller 597 is heated and pressurized by a fixing unit 525 to be fixed to the sheet P, and as a result, a printed matter is printed by the image forming apparatus 5. That is, the image forming unit 523 transfers the image to the sheet P by performing image formation by an electrophotographic process. Note that, a drum cleaning device 595 is provided around each of the photoconductors 594. The drum cleaning device 595 removes residual toner remaining on the intermediate transfer belt 596. The conveyance path 521 is a path for feeding and conveying the sheet P from the sheet feeding unit 520. Specifically, an image is formed on the sheet P fed from the sheet feeding unit 520 by the image forming unit 523 and the fixing unit 525, and the sheet P is sequentially conveyed to either one of the stacker 1, or the stacker 201 via the stacker 1. Thus, the sheet P is sequentially conveyed to either one of the stacker 1 or the stacker 201 from the image forming apparatus 5 that is an apparatus provided on the preceding-stage side.

Note that, even if the function of the automatic external ejection processing of the stacker 1 is set to be disabled and the function of the automatic external ejection processing of the stacker 201 is set to be enabled, there is a case where the user does not desire execution of the automatic external ejection processing also in the stacker 201. In such a case, the user is made to stop the execution of the automatic external ejection processing of the stacker 201, or the stacker 201 disables the function of the automatic external ejection processing. Specifically, the controller 41 inquires, of the user, whether or not to execute the automatic external ejection processing of the stacker 201 that is the subsequent-stage side ejection destination, or performs setting change from being enabled to being disabled of the function of the automatic external ejection processing of the stacker 201 that is the subsequent-stage side ejection destination, before the print job is executed, when the function of the automatic external ejection processing of the stacker 201 that is the subsequent-stage side ejection destination is set to be enabled and the function of the automatic external ejection processing of the second tray 22 is set to be disabled.

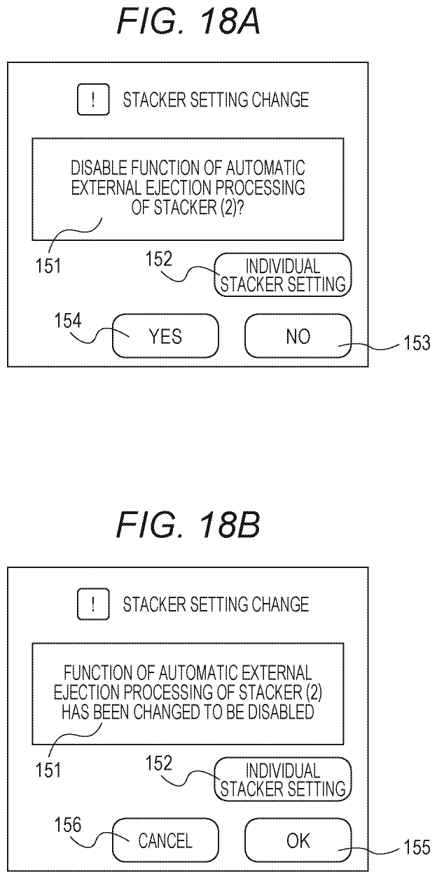

FIGS. 18A and 18B are diagrams each illustrating an example of a setting screen according to the seventh embodiment of the present disclosure. FIG. 18A is an example in which the user is made to set the function of the automatic external ejection processing to be disabled. In the example of FIG. 18A, in a notification area 151, the user is notified of whether or not to disable the function of the automatic external ejection processing of the stacker 201 selected by a button 152, and it is a state of waiting for that either a button 153 or a button 154 is operated by the user. On the other hand, FIG. 18B is an example in which the function of the automatic external ejection processing is automatically set to be disabled. In the example of FIG. 18B, in the notification area 151, the user is notified that the function of the automatic external ejection processing of the stacker 201 selected by the button 152 has been disabled, and it is a state of waiting for that the processing is determined by operation of buttons 155 and 156 by the user.

From the above description, in the seventh embodiment, it is inquired, of the user, whether or not to execute the automatic external ejection processing with the subsequent-stage side ejection destination, or the setting change is performed from being enabled to being disabled of the function of the automatic external ejection processing of the subsequent-stage side ejection destination, before the print job is executed, when the function of the automatic external ejection processing of the subsequent-stage side ejection destination is set to be enabled and the function of the automatic external ejection processing of the second tray 22 is set to be disabled. Thus, even when the user does not desire to execute the automatic external ejection processing of the subsequent-stage side ejection destination, the automatic external ejection processing of the subsequent-stage side ejection destination can be disabled. Therefore, processing can be executed that reflects the user's intention.

In addition, in the seventh embodiment, since the sheet P on which an image is formed by the image forming apparatus 5 is supplied to the ejector 16 included in the stacker 1, an image forming system can be constructed that ensures productivity.

In the above, the stacker 1 according to the present disclosure has been described with reference to the first to seventh embodiments; however, the present disclosure is not limited thereto, and modifications may be made without departing from the spirit of the present disclosure.

For example, in the present embodiments, an example has been described in which the stacking count number is incremented by +1, as stacking count number update processing; however, the present disclosure is not particularly limited thereto. For example, depending on a set value of the full count number, it may be increased by +0.1, or may be decreased by −1. That is, it is sufficient that it can be determined whether the stacking amount of the sheets P of the first tray 21 has reached an upper limit value.

In addition, an example has been described in which the notifier 51 and the setter 52 are separately provided; however, the present disclosure is not particularly limited thereto. The notifier 51 and the setter 52 may be integrally provided. In addition, the main body setting unit 508 may have the functions of the notifier 51 and the setter 52.

Although embodiments of the present invention have been described and illustrated in detail, the disclosed embodiments are made for purposes of illustration and example only and not limitation. The scope of the present invention should be interpreted by terms of the appended claims.

What is claimed is:

1. A stacker comprising:
an ejector that ejects a sheet on which an image is formed depending on a print job to an ejection destination;
a first tray on which the sheet ejected by the ejector is stacked, as the ejection destination;
a second tray that is a delivery destination of the sheet stacked on the first tray and with which automatic external ejection processing that ejects the sheet externally is executable;
a setter that accepts a setting detail in which it is set whether or not to execute the automatic external ejection processing executable with the second tray; and
a hardware processor that controls whether or not to execute the automatic external ejection processing depending on the setting detail, when the sheet satisfies a target condition in which the sheet becomes a target sheet of the automatic external ejection processing, wherein
the hardware processor
continues stacking of the sheet on the first tray when not executing the automatic external ejection processing.

2. The stacker according to claim 1, wherein
the setting detail includes:
a default setting that sets a function of the automatic external ejection processing to be either enabled or disabled; and
an exception setting that sets the function of the automatic external ejection processing to be disabled when an abnormality occurs internally, wherein
the exception setting
takes precedence over the default setting.

3. The stacker according to claim 2, wherein
the hardware processor,
when the function of the automatic external ejection processing is set to be disabled, does not eject the second tray externally until operation for taking out the second tray is performed, and enables external ejection of the second tray after the operation for taking out the second tray is performed.

4. The stacker according to claim 2, wherein
the hardware processor
determines availability of operation for taking out the second tray depending on a constraint condition, and
the constraint condition
constrains the operation for taking out the second tray.

5. The stacker according to claim 4, further comprising
a notifier that performs notification of an operation procedure of the second tray, wherein the notifier
changes a notification detail of the operation procedure of the second tray, depending on whether the function of the automatic external ejection processing is set to be enabled or disabled.

6. The stacker according to claim 5, wherein
the target condition
includes a variable condition and a fixed condition,
the variable condition
is a parameter relating to the print job, and is determined based on at least one of a number of jobs, a number of copies, a number of printed pages, a sheet size, a basis weight, or a sheet type,
the fixed condition
is determined based on specifications of the first tray and the second tray, arid
the hardware processor
determines that the sheet is the target sheet when at least one of the variable condition or the fixed condition is satisfied.

7. The stacker according to claim 6, wherein
the hardware processor
executes the automatic external ejection processing, when the sheet satisfies the target condition due to an execution detail of the print job and the function of the automatic external ejection processing is set to be enabled,

8. The stacker according to claim 5, wherein
the hardware processor
changes a sheet interval of the sheet to be ejected to the first tray to greater than or equal to a time equivalent required for the operation for taking out the second tray, when the function of the automatic external ejection processing is set to be enabled and the operation for taking out the second tray is performed.

9. The stacker according to claim 5, wherein
a subsequent-stage side ejection destination is provided on a subsequent-stage side from the first tray, as the ejection destination, and the automatic external ejection processing is executable with the subsequent-stage side ejection destination, and the ejection destination is switchable to either one of the first tray or the subsequent-stage side ejection destination, and
the hardware processor
inquires, of a user, whether or not to execute the automatic external ejection processing with the subsequent-stage side ejection destination, or performs setting change from being enabled to being disabled of the function of the automatic external ejection processing of the subsequent-stage side ejection destination, before the print job is executed, when the function of the automatic external ejection processing of the subsequent-stage side ejection destination is set to be enabled and the function of the automatic external ejection processing of the second tray is set to be disabled.

10. The stacker according to claim 5, wherein
the constraint condition
is satisfied when the operation for taking out the second tray is performed while the sheet is stacked on the first tray, or when the automatic external ejection processing with the second tray is executed, and
the hardware processor
disables the operation for taking out the second tray when the constraint condition is satisfied.

11. The stacker according to claim 5, wherein
the hardware processor,
when disabling the operation for taking out the second tray, performs at least one operation of operation for locking the second tray with a lock mechanism, operation for stopping a function relating to execution of the print job at time of detection of the operation for taking out the second tray, or operation for changing the notification detail with the notifier.

12. The stacker according to claim 5, further comprising
an actuator that moves the second tray externally, wherein
the exception setting
is a condition set depending on whether or not the actuator is in an abnormal state, and
the hardware processor
controls the second tray, based on the exception setting.

13. An image forming system comprising:
a stacker according to claim 1; and
an image forming apparatus that is provided on a preceding-stage side of the stacker and forms an image on a sheet, wherein
the image forming apparatus
supplies the sheet on which the image is formed to an ejector of the stacker.
